(19) United States
(12) Patent Application Publication
(10) Pub. No.: US 2026/0366379 A1
(43) Pub. Date: Nov. 19, 2026

(54) CAP

(71) Applicant: TechnipFMC Norge AS, Kongsberg (NO)

(72) Inventor: Per Inge Myran, Kongsberg (NO)

(21) Appl. No.: 19/158,798

(22) PCT Filed: Feb. 21, 2024
(86) PCT No.: PCT/EP2024/054396

§ 371 Date: Aug. 21, 2025

(30) Foreign Application Priority Data
Feb. 24, 2023 (NO) 20230181

(51) Int. Cl. E21B 17/01; F16L 57/00

(52) U.S. Cl. CPC E21B 17/01; F16L 57/005

(57) ABSTRACT

A cap for protecting a sealing surface area of a riser unit. The cap comprises a body, a lock, and a fastener. The body comprises a circumferential load shoulder for an axial end of the riser unit, and a first area with an inner profile. The lock pivotally connected to the body, the lock comprising a second area with the inner profile. The fastener for releasably fastening the lock to the body and thereby also, when in use, fastening the cap to the end of the riser unit. The cap comprises a first clearance between the body and the lock, the first clearance extending in an axial direction of the body and allowing thermal expansion of the body and the lock.

### TECHNICAL FIELD

The present disclosure relates to a cap for protecting a sealing surface of a riser unit used in the oil and gas industry. More particularly, the present disclosure relates to a protection system for providing drilling riser protection and facilitate storage.

### BACKGROUND

Riser units are pipes delivering fluid between subsea equipment and offshore structures in the oil and gas industry. The risers are used for drilling or production purposes. When transporting and storing, these riser units are always subject to potential damage.

It is a problem to store efficiently and to protect the drilling risers from impact damage during handling operations in a riser unit storage.

A further problem is that drilling risers are sometimes stored outside the warehouse, and preventing foreign material or rainwater from contaminating the coupling threads and protecting the riser units, especially riser unit end connectors, is necessary to minimise damage.

A further problem is that any protection must also comply with regulations and standards in the oil and gas industry. A change in temperature of the environment can cause thermal expansion, and this can cause problems for the dimensions of a protection and how the protection fits a riser unit.

A further technical problem is that any part of a cap for protecting a sealing surface of a riser unit and its replacement must function without a possibility to fail, fulfill technical and legal requirements, and be easy to use. It is desirable that any solution is simple, not expensive to produce, and is reliable. It is further a technical problem to avoid cumbersome arrangements that are expensive to manufacture or assemble. Any such cap must also withstand weather conditions and heating in the sun.

To minimise damage during operation and/or storage, there is a need for improvement to store and protect the riser units effectively in terms of logistics costs, convenience, and safety. It is desirable to provide a solution to this problem, and more specifically, to provide a riser unit with protection and to facilitate storage.

### SUMMARY

Embodiments of the present disclosure provide a cap for protecting a sealing surface area of a riser unit.

According to an embodiment, a cap for protecting a sealing surface area of a riser unit is provided. The cap comprises a body, a lock, and a fastener. The body comprises a circumferential load shoulder for an axial end of the riser unit, and a first area with an inner profile. The lock is pivotally connected to the body, the lock comprising a second area with the inner profile. The inner profile may be compatible with a part of the sealing surface area of the riser unit. The fastener is for releasably fastening the lock to the body and thereby also, when in use, fastening the cap to the end of the riser unit. The cap comprises a first clearance between the body and the lock, the first clearance extending in an axial direction of the body and allowing thermal expansion of the body and the lock.

According to an embodiment, the cap may further comprise an element, the element may be substantially a hollow cylinder. The body may be attachable to a first axial end of the element 100. The cap may further comprise a second clearance between the lock and the element, the second clearance extending in an axial direction of the element and allowing thermal expansion of the element and the lock.

According to one embodiment, the element may further comprise a third clearance between the element and a part of the riser unit when the cap is connected to the riser unit. The third clearance may extend in an axial direction of the element and may allow thermal expansion of the element and the riser unit.

The above mentioned embodiments provide one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The accompanying drawings illustrate example embodiments of the disclosure and serve to explain, by way of example, the principles of the disclosure.

FIG. 1 is a diagrammatic illustration of a cap according to an example embodiment of the disclosure;

FIG. 2 is a diagrammatic illustration of a sectional view of the example embodiment of the cap according to FIG. 1; and

FIG. 3 is a diagrammatic exploded illustration of separated parts of the cap according to the example embodiment of the disclosure.

### DETAILED DESCRIPTION

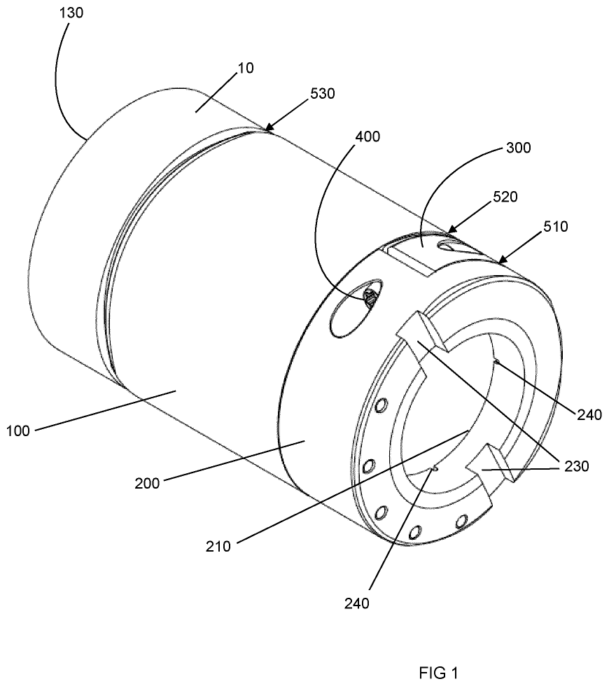

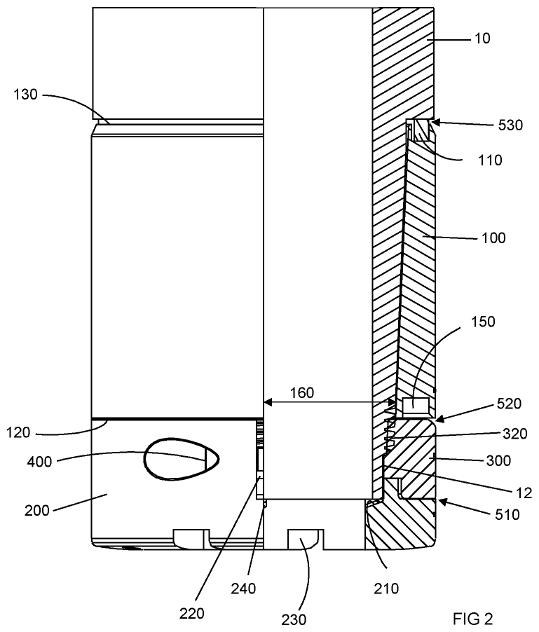

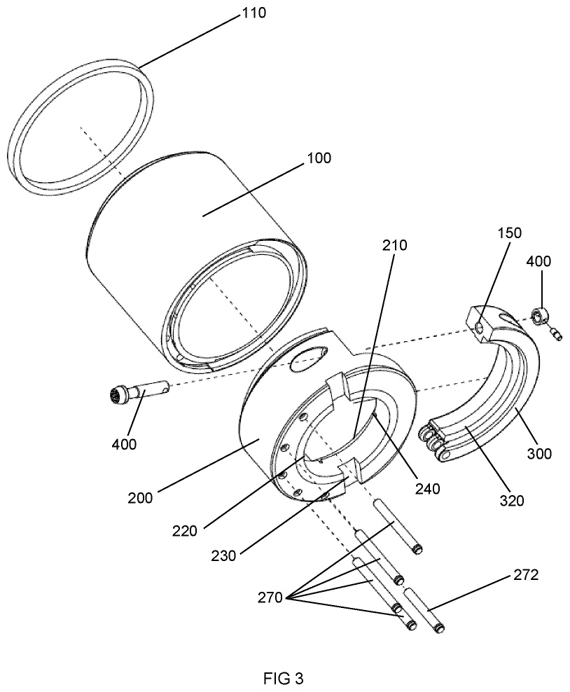

FIGS. 1, 2, and 3 are diagrammatic illustrations of an example embodiment of the cap. FIGS. 1 and 2 illustrate an example embodiment of the cap when attached to a riser unit, FIG. 2 illustrates a cut-through view of the cap and a part of the rising unit, and FIG. 3 illustrates an exploded view of the cap.

With reference to FIGS. 1 to 3, there is shown an example embodiment of a cap. The illustrated cap is formed from a body 200, a lock 300, and a fastener 400. The cap is for protecting a sealing surface area 12 of a riser unit 10. The riser unit may be a part of a drill string, a drill pipe, or other pipe or tubular elements used in the oil and gas industry. Only a short end part of the riser unit 10 is illustrated in FIGS. 1 and 2. The cap may be used for protecting the ends, especially the coupling at the ends of such a riser unit 10. The cap may be known as a racking cap, because the riser units 10 may be stored in a rack. The sealing surface area 12 may be a threaded part, or another part, that seals between two riser units 10 when they are connected to each other. This is the part that should remain intact and therefore needs protection when not in use.

The body 200, as illustrated in FIG. 1 to 3, comprises a circumferential load shoulder 210 for an axial end of the riser unit 10, and a first area 220 with an inner profile. The inner profile may be compatible with a part of the sealing surface area 12 of the riser unit 10. The body 200 may be substantially circumferential, and in further embodiments having a similar outer diameter as the outer diameter of the rising unit 10. The shoulder 210 may be perpendicular to an axis of the body 200. The axis may be along the center of the body 200 and the riser unit 10 when the riser unit 10 is connected to the body 200. The shoulder 210 may be in contact with the axial end of the riser unit 10 when the body 200 is connected to the riser unit 10. The inner profile of the first area 220 may connect and/or protect the sealing surface area 12 of the riser unit 10.

The lock 300, as illustrated in FIGS. 1 to 3, is pivotally connected to the body 200. The lock 300 may be a locking element 300. The lock 300 comprises a second area 320 with the inner profile. The inner profile may be compatible with a part of the sealing surface area 12 of the riser unit 10. The cap comprises a first clearance 510 between the body 200 and the lock 300, the first clearance 510 extends in an axial direction of the body 200 and allows thermal expansion of the body 200 and the lock 300. The first clearance is specifically needed for allowing the materials of the body 200 and the lock 300, for example, a plastic material, to expand and/or contract so that the lock 300 does not get jammed against the body 200. This thermal expansion may vary based on material depending on environmental temperature, for example, from minus 30 degrees Celsius to plus 100 degrees Celsius, or from minus 30 degrees Celsius to plus 75 degrees Celsius.

The fastener 400, as illustrated in FIGS. 1 to 3, is for releasably fastening the lock 300 to the body 200. The fastener 400 is also for fastening the cap to the end of the riser unit 10. The fastener 400 attaches the lock 300 to the body 200. The lock 300 and the fastener 400 form a counterpart with each other. The fastener 400 may be at one end of the lock 300, and at the other end of the lock 300 may be a movable mechanism on which the lock 300 may pivot to open and close. The movable mechanism may be a hinge, a joint, or any other corresponding mechanism.

The cap may further comprise an element 100, as illustrated in FIGS. 1 to 3, that is substantially a hollow cylinder. The body 200, the lock 300, and the fastener may function as a cap with or without the element 100. The body 200 may be attachable to a first axial end 120 of the element 100. The cap may further comprise a second clearance 520 between the lock 300 and the element 100, the second clearance 520 extends in an axial direction of the element 100 and allowing thermal expansion of the element 100 and the lock 300. The second clearance 520 is advantageous for preventing a jammed or “thread lock” situation. For example, when the body 200 and the lock 300 are connected with each other, and both the circumferential load shoulder 210 and the second area 320 interface with the cap, it may not be possible to loosen the cap from the riser unit or open the lock 300, because of expansion of the parts of the cap due to heat increase, for example, caused by sun light. The thermal expansion described herein for the three clearances may be variations in a material depending on the temperature of the environment heating or cooling the cap, for example, from minus 30 degrees Celsius to plus 100 degrees Celsius, or from minus 30 degrees Celsius to plus 75 degrees Celsius.

The element 100, as illustrated in FIGS. 1 to 3, may further comprise a third clearance 530 between the element 100 and a part of the riser unit 10 when the cap is connected to the riser unit 10. The third clearance 530 may extend in an axial direction of the element 100 and may allow thermal expansion of the element 100 and the riser unit 10. The third clearance 530 is advantageous for allowing thermal expansion of the element 100 and the riser unit 10.

According to one embodiment, as illustrated in FIGS. 1 to 3, the element 100 may further comprise a sealing element 110. The sealing element 110 is circumferential, and it may be attached to a second axial end 130 of the element 100. The sealing element 110 is for filling the third clearance 530. The purpose of the sealing element 110 is to prevent foreign material and/or rainwater from contaminating the coupling threads of the second axial end 130 of the element 100 and protect the riser unit. The sealing element 110 may be in a form of a circumferential plastic protector, a rubber ring, or a soft foam seal ring.

According to one embodiment, as illustrated in FIGS. 1 to 3, the body 200 may comprise a drainage opening 240. The drainage opening 240 is directed inwards of the body 200. The drainage opening 240 leads fluid to the inner diameter of the body 200 and the lock 300, to the bottom of the cap in FIG. 2. The drainage openings 140 can be seen in FIGS. 1, 2, and 3. There may be 3, 4, 5, or 6 drainage openings 140 equally distanced along the circumferential inside of the body 200 and the lock 300. This allows fluid to exit the cap, especially when the riser unit is standing axially on the cap. The drainage opening 140 may allow fluid between the cap and the riser unit to exit.

According to one embodiment, as illustrated in FIGS. 1 to 3, the element 100 may comprise a hollow portion 150 corresponding to and opposite the lock 300 when the lock 300 is fastened by the fastener 400. The hollow portion 150 may be an opening facing circumferentially in an axial direction towards the body 200. The hollow portion 150 may also allow additional space to the lock 300. The hollow portion 150 may be used by fastener 270. The hollow portion may be used by a hinge pin 272.

According to one embodiment, the fastener 400 may be arranged completely inside the body 200. In some embodiments, the fastener may not protrude beyond the radial outside of the body 200. This improves the functionality and life span of the cap since the fastener 400 between the body 200 and the lock 300 is protected.

According to one embodiment, as illustrated in FIGS. 1 to 3, an inside radius 160 of the element 100 may constantly increase from the first axial end 120 of the element 100 to the second axial end 130 of the element 100. In FIG. 2, the radius 160 is indicated at the smaller end of the element 100, and the radius 160 increases when moving upwards in FIG. 2. The element 100 may have internally a truncated cone shape, as may be best taken from FIG. 2.

According to one embodiment, at least one of the element 100, the body 200, and the lock 300 may be made out of a non-metallic material. The material may be a synthetic or semi-synthetic material with a polymer.

According to one embodiment, as illustrated in FIGS. 1 to 3, the body 200 may further comprise a radial groove 230 on an outside of the body 200. The radial groove 230 may extend over the diagonal of the end facing away from the riser unit when the cap is attached to the riser unit. The groove 230 may comprise a plurality of grooves. The grove is advantageous for rotating the cap and/or the riser unit 10 itself. A tool may be inserted into the groove 230 so as to rotate the cap.

According to one embodiment, as illustrated in FIGS. 1 to 3, the element 100 may be thinner at a second axial end 130 of the element 100 than at the first axial end 120 of the element 100. This is advantageous when the sealing element 110 is connected to the second axial end 130 of the element 100.

According to one embodiment, as illustrated in FIGS. 1 to 3, the element 100 may be substantially cylindrical with a hollow cone inside. The body 200 may be substantially a hollow cylinder. The element 100, and/or the body 200, may be substantially circumferential, having a similar diameter as the diameter of the riser unit 10.

According to one embodiment, as illustrated in FIGS. 1 to 3, the fastener 400 may be one of the group consisting of: a bolt and nut, a clamp, a lever, a key, and a latch. For example, the bolt and the nut may attach one end of the lock 300 to the body 200 to clamp the cap onto the riser unit 10.

According to one embodiment, as illustrated in FIGS. 1 to 3, the element 100 and the body 200 may be attached to each other by fastener 270, 272. As best illustrated in FIG. 3, a plurality of fastener 270, 272, for example, five bolts, may be used to attach the element 100 to the body 200. The fastener may be any suitable fastener, such as screws, bolts, plugs, pins, nails, etc. The fastener 270, 272 may be arranged in the axial direction and arranged only on the part of the body 200 where the lock 300 is not arranged. The fastener 270 may be assembly pins connecting the element 100 with the body 200. One of the assembly pins, assembly pin 272, may additionally, or separately, function as a hinge pin 272 for the lock 300, connecting the element 100, the body 200, and the lock 300. This allows the lock 300 to swing about the fastener 272. The body 200 and the element 100 may have complementary shapes to connect to each other. The lock 300 may not have such complementary shapes to connect to the body 200 and the element 100.

One of the advantages of at least one embodiment described herein is that the lock 300, which is partly hinged, may freely fold out and fall in, especially during torque/un-torque, or during heating by the sun, when using the cap. The rotation, the torque/un-torque, of the body 200 allows the lock 300 to be opened and closed without jamming. Heating of the cap by weather conditions also allows the lock 300 to be opened and closed without jamming.

This written description uses examples to disclose the various embodiments disclosed herein, including the best mode, and also to enable any person skilled in the art to practice the embodiments, including making and using the cap. The patentable scope of the embodiments are defined by the claims, and includes other examples that occur to those skilled in the art. Such other examples are intended to be within the scope of the claims if they have structural elements that do not differ from the literal language of the claims, or if they include equivalent structural elements with insubstantial differences from the literal languages of the claims.

### LIST OF ELEMENTS

10 riser unit
12 sealing surface area
100 element
110 sealing element
120 first axial end
130 second axial end
150 hollow portion
160 inside radius of the element
200 body
210 circumferential load shoulder
220 first area
230 groove
240 drainage opening
270 fastener
272 fastener and hinge
300 lock
320 second area
400 fastener
510 first clearance
520 second clearance
530 third clearance

1. A cap for protecting a sealing surface area of a riser unit, the cap comprising:
a body, the body comprising a circumferential load shoulder for an axial end of the riser unit, and a first area with an inner profile;
a lock pivotally connected to the body, the lock comprising a second area with the inner profile; and
a fastener for releasably fastening the lock to the body and thereby also, when in use, fastening the cap to the end of the riser unit,
wherein the cap comprises a first clearance between the body and the lock, the first clearance extending in an axial direction of the body and allowing thermal expansion of the body and the lock.

2. The cap according to claim 1, further comprising:
an element the element being substantially a hollow cylinder;
the body (200) being attachable to a first axial end (120) of the element (100);
the cap further comprising a second clearance between the lock and the element, the second clearance extending in an axial direction of the element and allowing thermal expansion of the element and the lock.

3. The cap according to claim 2, wherein the element comprises a third clearance between the element and a part of the riser unit when the cap is connected to the riser unit, the third clearance extending in an axial direction of the element and allowing thermal expansion of the element and the riser unit.

4. The cap according to claim 3, wherein the element comprises a sealing element, the sealing element being circumferential and attached to a second axial end of the element and filling the third clearance.

5. The cap according to claim 1, wherein the body comprises a drainage opening.

6. The cap according to claim 5, wherein the drainage opening is directed inwards out of the body for leading fluid to an inner diameter of the body and the lock.

7. The cap according to claim 1, wherein the fastener is arranged completely inside the body.

8. The cap according to claim 4, wherein an inside radius of the element is constantly increased from the first axial end of the element to the second axial end of the element.

9. The cap according claim 2, wherein at least one of the element, the body, and the lock is made out of a non-metallic material.

10. The cap according to claim 1, wherein the body comprises a radial groove on an outside.

11. The cap according to claim 1, wherein the body is substantially a hollow cylinder.

12. The cap according to claim 1, wherein the fastener is one of the group consisting of: a bolt and nut, a clamp, a lever, a key, and a latch.

13. The cap according to claim 2, wherein the element and the body may be attached to each other by a fastener.

14. The cap according to claim 2, wherein the element is thinner at a second axial end of the element than at the first axial end of the element.

15. The cap according to claim 2, wherein the element is substantially cylindrical with a hollow cone inside.
